(19) United States
(12) Patent Application Publication
(10) Pub. No.: US 2020/0167072 A1
(43) Pub. Date: May 28, 2020

(54) ACCESSIBLE DEVICE AND CONFIGURATION METHOD

(71) Applicant: Daniel MacKay, Saint-Basile-le-Grand (CA)

(72) Inventor: Daniel MacKay, Saint-Basile-le-Grand (CA)

(21) Appl. No.: 16/779,647

(22) Filed: Feb. 2, 2020

(51) Int. Cl. G06F 3/0489; G06F 3/0485; G06F 3/041

(52) U.S. Cl. CPC G06F 3/04897; G06F 3/0412; G06F 3/0485

(57) ABSTRACT

A device includes a display, a processor module operatively connected with the display, and a memory module operatively connected with the processor module. The memory module stores an application executable by the processor module to display a graphical user interface (GUI) on the display and to provide a plurality of functions executable via the GUI, and instructions. The instructions are executable by the processor module to display a surrogate active area on the display instead of the GUI, the surrogate active area mapped to a function of the plurality of functions. A method of configuring a device is also disclosed.

### TECHNICAL FIELD

The present technology relates to accessible devices and methods of configuring devices for persons with special visual and/or cognitive needs.

### BACKGROUND

Persons with reduced capabilities such as vision, hand motor function, memory, and the like, may suffer material inconveniences if their access to devices, such as telephones for example, are limited. Prior art accessible devices and graphical user interfaces (GUIs) for such users exist.

An example of such prior art technology is described in U.S. Pat. No. ______, entitled “ ”, published on X, the abstract of which provides: “ ”. Another example of such prior art technology is described in U.S. Pat. No. ______, entitled “ ”, published on X, the abstract of which provides: “ ”.

There also exist prior art guidelines for designing accessible GUIs. An example has been published by Sergey Polyuk, entitled “A Guide to Interface Design for Older Adults” (hereinafter the “Prior Art Accessible GUI Guide”), accessed on Dec. 29, 2019 at https://www.toptal.com/designers/ui/ui-design-for-older-adults. The Prior Art Accessible GUI Guide advocates, for example: a) considering “visual accessibility when creating websites that are likely to be accessed by older adults”, b) considering “[s]hades of blue” which may “appear faded to seniors” and accordingly “potentially reducing contrast when blue elements are used in a design” while “overall” increasing color contrast, c) keeping “[t]ext and button sizes . . . large”, d) providing fonts of “a minimum of 16px”, e) labelling icons “with text whenever possible”, and the like.

The Prior Art Accessible GUI Guide provides one of the reasons for the long-felt and an ever-increasing need for improved accessible technologies: “According to the 2017 World Demographic Perspectives: Revised Report, it is expected that the number of people over the age of sixty will more than double by 2050 (from 962 million to globally to 2.1 billion), and triple by 2100 (to 3.1 billion). Globally, the group of people over sixty is growing more rapidly than any other demographic. As people age, there are certain physiological and cognitive changes that are almost inevitable. And while many who are over sixty have been around technology almost their entire adult lives, those physiological and cognitive changes need to be compensated for.”

Indeed, many prior art devices and software applications exist which appear to follow known accessibility principles and which are aimed at compensating for at least some possible variations in physiological and cognitive abilities of users. Additionally, prior art software exists which may be executed for example on a mobile device as part of an operating system, and which may be configured via the device to limit functionality of one or more application executed on the device. As an example, a type of prior art software is referred to as “Kiosk mode” or “Single app mode”. Such prior art software typically allows a device, such as a portable tablet, to be locked to a single one of multiple applications executable by the device. When enabled, this prior art software prevents a user from accessing any locked-out application and/or functionality of the device.

Another example of prior art software is referred to as “Guided Access”, available on devices such as the iPad™. “Guided Access” may allow to lock the device to a single application. “Guided Access” may further allow to disable at least a part of a touchscreen of the device so as to disable at least some of the functionality provided by the application to which the device may be locked. Thus, when the GUI of the application to which the device is locked is displayed, the device will not react to any user input received at the part of the touchscreen that is disabled. Further, “Guided access” may also allow certain keys of the device to be disabled—in the iPad™ example, the “Sleep/Wake Button”, “Volume Buttons”, “Motion”, “Keyboards”, and “Touch”. Further “Guided access” may allow a usage time limit to be enabled.

While prior art devices and software applications such as those described above are suitable for their intended purposes, improvements are possible.

### SUMMARY OF THE PRESENT TECHNOLOGY

In an aspect, the present technology provides a device, comprising: a display, a processor module operatively connected with the display, and a memory module operatively connected with the processor module, the memory module storing: an application executable by the processor module to display a graphical user interface (GUI) on the display and to provide a plurality of functions executable via the GUI, and instructions executable by the processor module to display a surrogate active area on the display instead of the GUI, the surrogate active area mapped to a function of the plurality of functions.

In some embodiments, the processor module is configured to display the surrogate active area on the display while simultaneously maintaining both: a) the GUI of the application invisible on the display, and b) the application executable at least with respect to the function such that the function is executable via the surrogate active area while the GUI of the application is invisible on the display.

In some embodiments, the surrogate active area is a plurality of surrogate active areas; the function is a plurality of functions; and each surrogate active area of the plurality of surrogate active areas is mapped to at least one function of the plurality of functions.

In some embodiments, the application is a plurality of applications; a first surrogate active area of the plurality of surrogate active areas is mapped to at least one function of a first application of the plurality of applications; and a second surrogate active area of the plurality of surrogate active areas is mapped to at least one function of a second application of the plurality of applications.

In some embodiments, the instructions are executable by the processor module to cause the processor module to display a given surrogate active area of the plurality of surrogate active areas on the display while simultaneously maintaining both: a) a rest of the plurality of surrogate active areas and the GUI invisible on the display, and b) the application executable with respect to the at least one function to which the given active area is mapped.

In some embodiments, the processor module is configured to display a given surrogate active area of the plurality of surrogate active areas on the display while simultaneously maintaining both: a) a rest of the plurality of surrogate active areas and the GUI invisible on the display, and b) the application active with respect to the at least one function to which the given active area is mapped.

In some embodiments, the processor module is configured to switch between displaying on the display the given active area and another active area of the plurality of surrogate active areas in response to a user input received at the processor module.

In some embodiments, the function is a plurality of functions that includes: a connect function executable via a first area of the GUI when the GUI is displayed on the display to connect the device with another device for exchanging with the other device one or both of speech and video, and a contacts access function executable via a second area of the GUI when the GUI is displayed on the display to display a plurality of contacts via the display; and the surrogate active area is mapped to both the connect function and the contacts access function.

In some embodiments, the connect function is executable via at least a part of the surrogate active area; and the contacts access function is executable via at least the part of the surrogate active area.

In some embodiments, the display is a touchscreen, the surrogate active area, when displayed on the touchscreen, displays in the surrogate active area a scrollable sequence of contacts that are associated with the contacts access function of the application, the scrollable sequence displaying in the surrogate active area at least one of the contacts at a time; and the connect function is executable by the processor module with respect to the at least one of the contacts in response to a touch input received at a portion of the touchscreen displaying the at least one of the contacts without the processor module waiting to receive further user input after receiving the touch input.

In some embodiments, the surrogate active area, when the surrogate active area is displayed on the touchscreen, occupies between 80% and 100% of the touchscreen.

In some embodiments, the portion of the touchscreen displaying the at least one of the contacts, when the surrogate active area is displayed on the touchscreen, occupies between 30% and 100% of the surrogate active area.

In some embodiments, the portion of the touchscreen displaying the at least one of the contacts, when the surrogate active area is displayed on the touchscreen, occupies between 80% and 100% of the surrogate active area.

In some embodiments, the device includes a communications module operatively connected with the processor module, and the communications module is operable to execute a connection attempt with respect to a device associated with the at least one of the contacts in response to the connect function being executed by the processor module.

In some embodiments, the scrollable sequence is non-alphanumeric.

In another aspect, the present technology provides a method of configuring a device having a display and an application executable on the device to display a graphical user interface (GUI), the application having a plurality of functions executable by a user via the GUI, the method comprising: configuring a processor module of the device to simultaneously: display a surrogate active area on the display instead of the GUI, the surrogate active area mapped to a function of the plurality of functions, and maintain the application operable by the processor module at least with respect to the function such that the application is executable by the processor module in response to a user input received by the processor module with respect to the surrogate active area.

In some embodiments, the method further comprises configuring the processor module to display a surrogate graphical user interface (S.GUI) on the display instead of the GUI while maintaining the application operable by the processor module at least with respect to the function, the surrogate active area being a part of the S.GUI.

In some embodiments, the user input is a second user input, and further comprising configuring the processor module to display the surrogate active area on the display instead of the GUI in response to a first user input.

In some embodiments, the configuring the processor module includes modifying an operating system of the device.

In some embodiments, the configuring the processor module includes storing instructions at least in part in a memory module of the device, the instructions being executable by the processor module to cause the processor module to simultaneously: display the surrogate active area on the display instead of the GUI, the surrogate active area mapped to the function of the plurality of functions, and maintain the application operable by the processor module at least with respect to the function such that the application is executable by the processor module in response to the user input received by the processor module with respect to the surrogate active area.

In yet another aspect, the present technology provides a mobile device, comprising: a touchscreen; a processor module operatively connected with the touchscreen; a communications module operatively connected with the processor module and operable to exchange at least voice data between a user of the device and a user of another voice-exchange-capable device; and a memory module operatively connected with the processor module and storing instructions executable by the processor module to display on the touchscreen a scrollable non-alphanumeric sequence of a plurality of contacts associated with the device, the scrollable non-alphanumeric sequence, when displayed on the touchscreen, displaying at least one of the contacts at a time and occupying between 80% and 100% of the touchscreen.

In some such embodiments, the processor module is configured to execute a connection attempt via the communications module with respect to a device associated with the at least one of the contacts in response to a touch input received at a portion of the touchscreen displaying the at least one of the contacts without waiting to receive further user input after receiving the touch input.

In some such embodiments, the processor module is configured to, in response to receiving the touch input and without waiting to receive further user input after receiving the touch input, display a non-alphanumeric representation of the at least one contact on the touchscreen while the connection attempt is being executed, the non-alphanumeric representation occupying between 80% and 100% of the touchscreen.

In some such embodiments, the processor module is configured to, in response to the connection attempt establishing a connection with the device associated with the at least one of the contacts, display another non-alphanumeric representation of the at least one contact on the touchscreen, the other non-alphanumeric representation occupying between 80% and 100% of the touchscreen.

In some such embodiments, the processor module is configured to, in response to receiving a touch input at the touchscreen over the other non-alphanumeric representation, terminate the connection without waiting to receive further user input after receiving the touch input over the other non-alphanumeric representation.

The embodiments above are non-limiting.

### BRIEF DESCRIPTION OF THE FIGURES

FIG. 1 is a schematic showing a device configured according to the present technology;

FIG. 2 is a schematic showing networks and other devices to one or more of which the device of FIG. 1 may be connectable;

FIG. 3 is a schematic showing the device of FIG. 1 displaying a graphical user interface (GUI) of an application being executed by said device;

FIG. 4 is a schematic showing the device of FIG. 1 displaying the GUI of FIG. 3, with the GUI being in another state;

FIG. 5 is a schematic showing the device of FIG. 1 displaying the GUI of FIG. 3, with the GUI being in another state;

FIG. 6 is a schematic showing a display of the device of FIG. 1, the display displaying thereon a surrogate graphical interface (S.GUI), possible surrogate active areas (S.A) of the S.GUI, and an example of possible mappings of the surrogate areas to one or more functions of an application executable by the device;

FIG. 7 shows the S.GUI of FIG. 6 in a given state;

FIG. 8 shows the S.GUI of FIG. 6 in another state;

FIG. 9 shows the S.GUI of FIG. 6 in yet another state;

FIG. 10 is a schematic showing the display of the device of FIG. 1, the display displaying thereon an S.GUI′, which is another embodiment of the S.GUI, possible surrogate active areas (S.A′) of the S.GUI′, and an example of possible mappings of the surrogate areas of the S.GUI′ to one or more functions of multiple applications executable by the device; and

FIG. 11 shows a method of configuring a device, such as the device of FIG. 1.

### DETAILED DESCRIPTION

For simplicity, due to the multitude of different possible configurations that may all provide a given one or more function(s), the present document describes various devices and functions with respect to modules. For example, a device may be described as having a module which may provide certain functions. The term “module” such a case should be understood to cover any one or more component(s), whether the component(s) is/are physically present in a single module in the device or distributed between different parts and/or other module(s) in the device, etc., so long as the component(s) is/are operable to provide the functions as described.

The present technology may be implemented on, and may help improve for at least some applications, at least some prior art hardware, such as smartphones, portable tablets, portable computers, and other voice-exchange and/or video-exchange enabled devices. In one aspect, a device configured according to the present technology may provide what is referred to herein as a “surrogate GUI”, or “S.GUI”. An S.GUI may be displayable by the device instead of one or more GUIs of one or more applications executable by the device. The S.GUI may have one or more active areas, each of which may be mapped to, for example, one or more functions of one or more of the application(s).

When mapped to a single application, the S.GUI, and hence the device, may provide a different way of accessing and/or executing one or more functions of the application than that provided by the application itself. In a more particular single-application-mapping embodiment, the S.GUI, and hence the device, may provide a user with a relatively more accessible way of accessing and/or executing one or more functions of the application than that provided by the application itself. As a more particular example, the S.GUI, and hence the device, may provide a simplified and/or a reduced subset of functions of the application which may be presented in a more visible and/or a more intuitive way to a user, such as a user with limited visual and/or cognitive ability, while using the existing application architecture in the background (i.e. not visible via the device while the S.GUI is being displayed) to execute the function(s), and hence without requiring a whole new “accessible application” or “device” to be built.

As another example, when mapped to two or more applications, the S.GUI, and hence the device, may provide the one or more functions of each of the applications via a single GUI (i.e. the S.GUI). In some such cases, the S.GUI may provide a new way of interacting with the one or more functions of the multiple applications, which may be different than the way(s) provided by each of the applications when executed without the S.GUI. In some embodiments, the present technology/method may avoid a programmer having to build one or more functions into the S.GUI and/or the device providing the function(s) by mapping to the function(s)/architecture of existing applications and/or in a more intuitive and/or accessible interface. It is contemplated that the present technology may have yet further and/or different applications than those described herein, and may likewise provide at least some advantages in such other applications. Particular non-limiting embodiments of the present technology are described herein next.

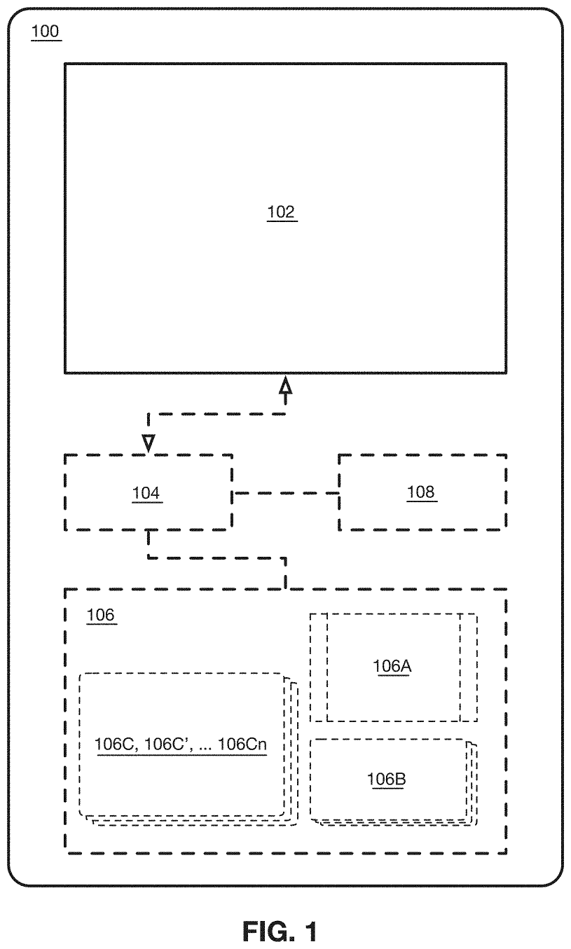

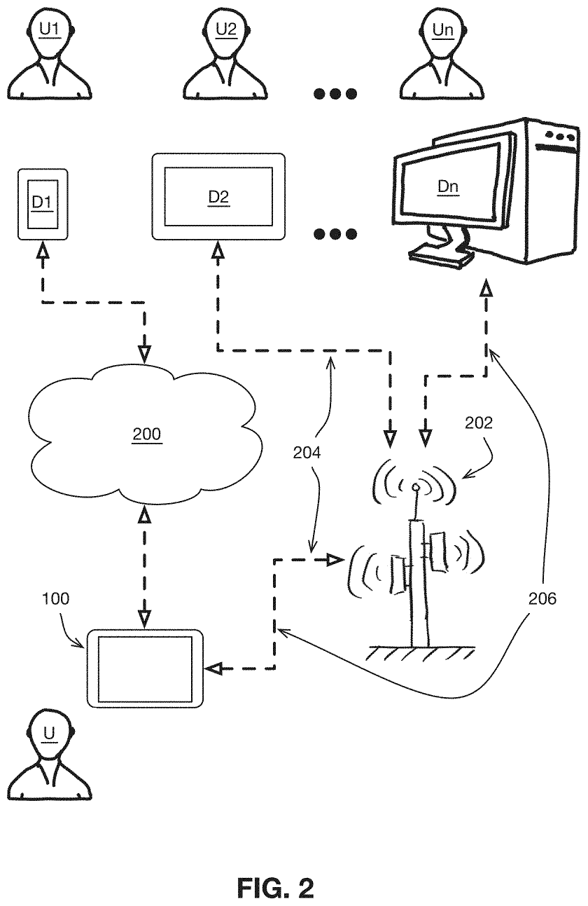

Referring to FIG. 1, there is shown a device 100 configured according to the present technology. The device 100 may have been a conventional device prior to being configured according to the present technology. To give non-limiting examples, in terms of hardware, the device 100 may be a conventional smart phone, portable tablet, personal computer, and the like. In other embodiments, the device 100 may be another device. As shown in FIG. 2, in this embodiment, the device 100 is a voice-exchange-capable device, meaning it is capable of connecting to one or more other devices D1, D2, . . . Dn via one or more networks, such as the internet 200 and/or a cellular network 202, and thereby allowing a user U of the device 100 to speak with a user U1, U2, . . . Un of the connected-to device(s) D1, D2, . . . Dn. Further in the present embodiment, the device 100 may also be a video-exchange-capable device.

As shown in FIG. 1, in this embodiment the device 100 includes a display 102, a processor module 104 operatively connected with the display 102, and a memory module 106 operatively connected with the processor module 104. In the present embodiment, the display 102 is a touchscreen, such as a conventional touchscreen for example. User inputs, and more particularly touch inputs, are receivable by the processor module 104 via the touchscreen 102, to operate the device 100. In some embodiments, the display 102 need not be a touchscreen. In such embodiments, user inputs may be receivable by the processor module 104 via for example one or more buttons on the device 100, a keyboard, mouse, and/or other suitable input devices, such as conventional input devices, which may be built into or connected to the device 100.

The processor module 104 includes one or more processors, such as any conventional processor(s) suitable for each particular embodiment of the device 100 and suitable for executing the various applications and software that may be executed by the device 100 as described herein. The memory module 106 may include and/or be non-transitory memory, such as conventional non-transitory memory, and may be selected to enable operation of the device 100 at least as the operation is described herein. While in the present embodiment the memory module 106 is a local memory module physically contained in the device 100 in its entirety, in other embodiments the memory module 106 may be at least in part remote to the device 100, such as stored on the cloud (i.e. at one or more remote server(s)) for example.

As shown schematically in FIG. 1, the memory module 106 may store an operating system 106A, such as a conventional operating system enabling operation of the device 100. As a non-limiting example, it is contemplated that the present technology may be implemented with and/or using the iOS™ operating system, by Apple Inc. In other embodiments, the operating system 106A may be an Android™ operating system for example, and the device 100 may hence be an Android™ device 100. The memory module 106 may further store instructions 106B, and one or more applications 106C, 106C′, . . . 106Cⁿ, each executable by the processor module 104.

The instructions 106B may be implemented using any suitable programming and/or engineering methods and/or languages, such as conventional programming and/or engineering methods and/or languages selected by a person skilled in the art using the person's common general knowledge to be suitable for each particular embodiment of the device 100, to provide for the functionality described herein.

The application(s) 106C, 106C′, . . . 106Cⁿ may include one or more communications (i.e. voice and/or video exchange) applications, such as one or more conventional communications application(s) (e.g. Skype™, WhatsApp™, FaceTime™, “built-in” phone application(s), and the like). Such one or more communication application(s)/the processor module 104 may use a communications module 108 of the device 100 to execute connection attempts, and connections (where the connection attempts are successful for example), with respect to one or more other devices D1, D2 . . . Dn associated with respective users U1, U2, . . . Un. The connection attempts, and connections (where the connection attempts are successful for example), from the device 100 with respect to one or more other devices D1, D2 . . . Dn, via one or more networks, are shown with double-ended arrows in FIG. 2. To enable the connectivity, the communication application(s) may include one or more functions, described in more detail herein, which may be implemented, for example using conventional programming methods, as instructions executable by the processor module 104 which cause the processor module 104 to correspondingly operate the communications module 108. Accordingly, the communications module 108 may for example include a conventional Wi-Fi™ sub-module and/or a conventional cellular sub-module, and/or a microphone and/or a video camera and/or a speaker, depending on each particular embodiment of the device 100 and according to the particular functionality of each embodiment of the device 100.

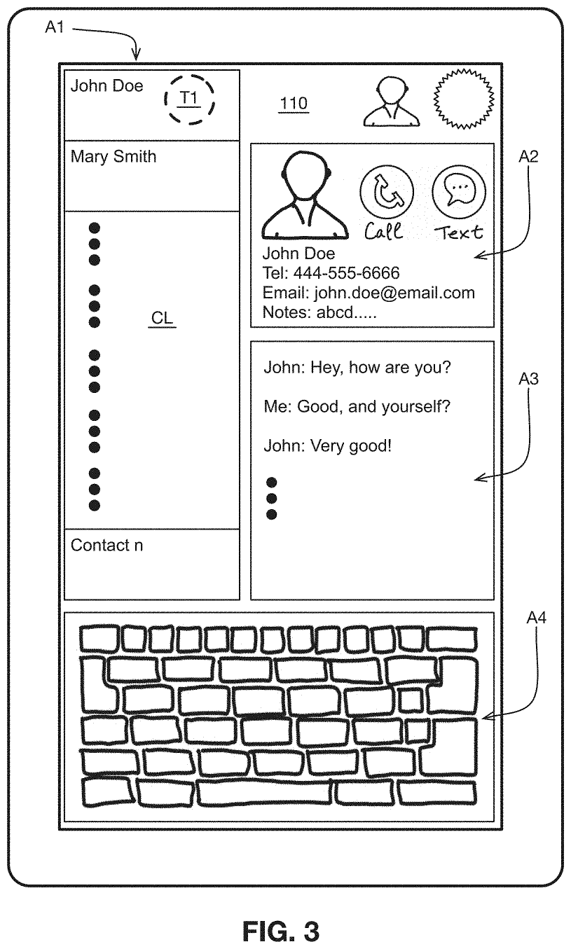

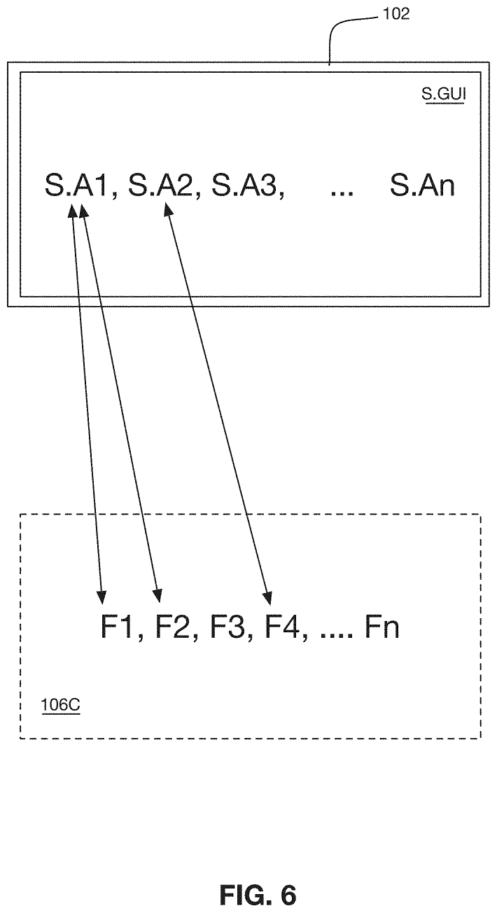

FIG. 3 shows the processor module 104 displaying on the touchscreen 102 a graphical user interface (GUI) 110 of an example one of the application(s) 106C, 106C′, . . . 106Cⁿ. The application 106C may be a conventional communications application 106C. As shown, the non-limiting example of the GUI 110 of the application 106C has multiple active areas A1, A2, A3 . . . An, each of which has one or more functions, as described in more detail below. As shown in FIG. 3, in this non-limiting example, active area A1 displays a contact list CL associated with the device 100 and thus provides a contacts access function F1 (FIG. 6). As shown in FIG. 3, the contacts access function F1 allows a user U (FIG. 2) of the device 100 to view one or more contacts that may be part of the contact list CL.

In this embodiment, active area A2 of the application 106C provides multiple functions. In this non-limiting embodiment, the functions include a call function F2 (FIG. 6, which is one example of a connect function), a texting function F3 (FIG. 6), and a call termination function F4 (FIG. 6). The application 106C may have yet other functions. For example, in some embodiments, the application 106C need not have a texting function F3 for example. Referring to FIG. 3, the application 106C in this embodiment is configured such that, to access the call and texting functions F2, F3 with respect to a given contact in the contact list CL, the user U first provides a user input, which in this embodiment is a touch input T1 at the touchscreen 102, over the given contact (i.e. within active area A1). To illustrate, the touch input T1 is shown over “John Doe”. Still referring to FIG. 3, the processor module 104 receives the touch input T1 and in response displays in active area A2 all of: contact information associated with the given contact, a “Call” button associated with the call function F2, and a “Text” button associated with the texting function F3.

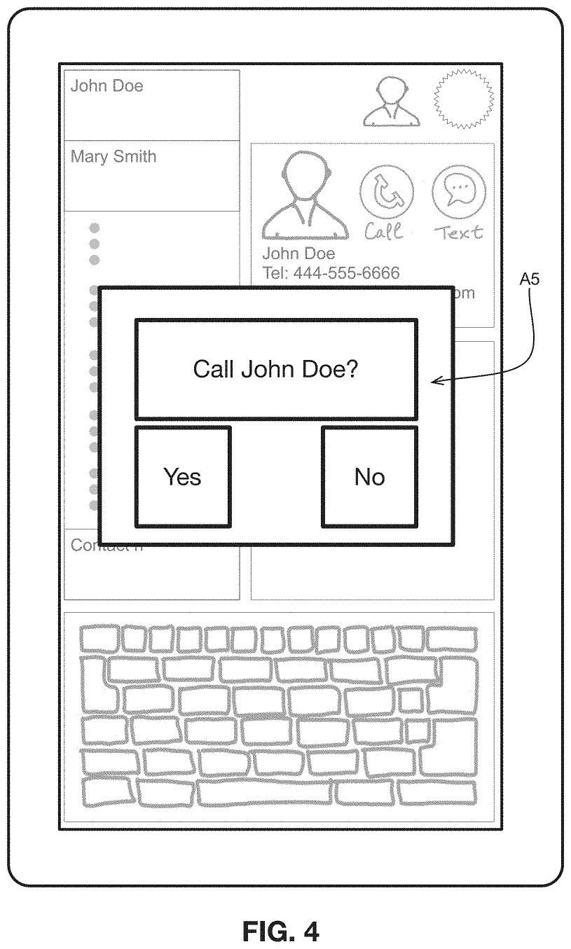

In this non-limiting embodiment, after the touch input T1, the user U provides a subsequent user input, in this embodiment a subsequent touch input, over one of the “Call” and “Text” buttons to execute the call function F2 or the texting function F3, respectively, via the communications module 108 with respect to a device associated with the given contact (in this example “John Doe”). Referring to FIG. 4, in this embodiment, in response to receiving the subsequent touch input, for example over the “Call” button, the processor module 104 displays an active area A5 requesting a confirmation from the user U via yet another subsequent touch input that the user U must provide in order for the call function F2 to be executed. Finally, for example in response to receiving the confirmation via the subsequent touch input over the “Call” button, the processor module 104 executes the call function F2 with respect to the given user.

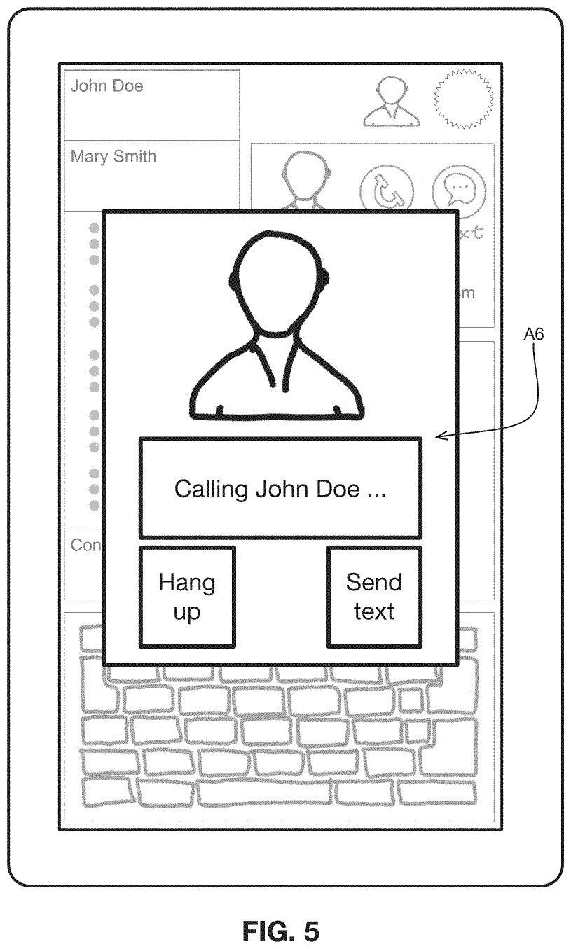

Further in response to receiving the confirmation via the third touch input, and as shown in FIG. 5, the processor module 104 displays yet another active area A6 with further buttons allowing the user U to either terminate the call function F2 (“Hang up” button) or send a text to the device associated with the given user (“Send text” button). Referring back to FIG. 3, in this embodiment, if the texting function F3 is executed by a touch input over the “Text” button in active area A2, a “chat” active area A3 and a “keyboard” active area A4 are displayed by the processor module 104. The functions F1, F2, . . . Fn provided by the active areas A1, A2, . . . An of the application 106C may be conventional, and/or any other functions and/or active areas. The functions F1, F2, . . . Fn of the application 106C are shown schematically in FIG. 6.

Referring to FIGS. 1 and 6, in the present embodiment, the instructions 106B (FIG. 1) according to the present technology may be executable by the processor module 104 to display a surrogate graphical user interface S.GUI on the display 102 instead of the GUI 110 of the application 106C. As shown in FIG. 6, the surrogate graphical user interface S.GUI has at least one surrogate active area S.A1. Further as shown, in the present non-limiting embodiment, the surrogate graphical user interface S.GUI has multiple surrogate active areas S.A1, S.A2, . . . S.An. More particularly, in this embodiment, the surrogate graphical user interface S.GUI has two surrogate active areas: S.A1, S.A2. However, as shown in FIG. 6, in other embodiments, the surrogate graphical user interface S.GUI may have a different number of surrogate active areas, and indeed any number depending on the application, including a single surrogate active area, or more than two surrogate active areas.

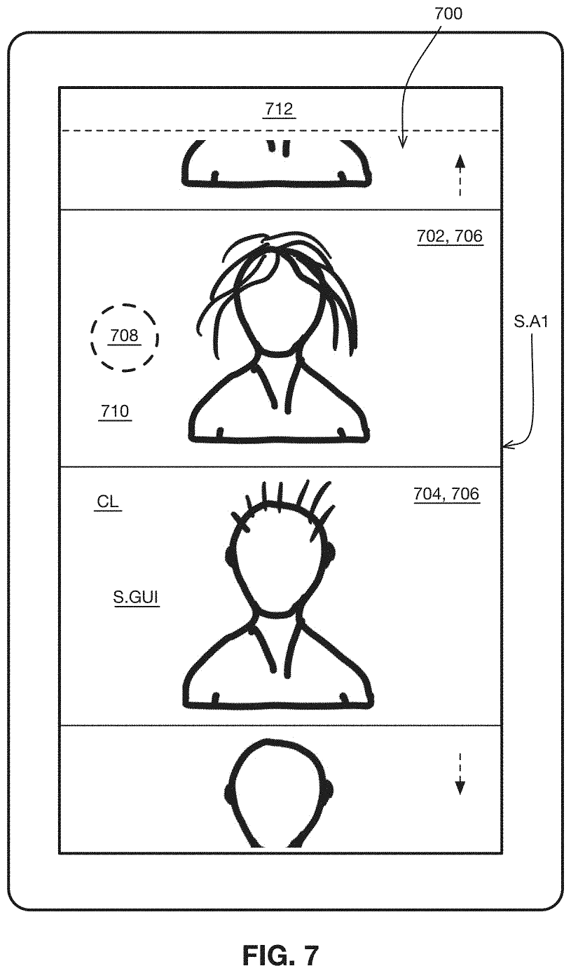

As will be seen from FIGS. 7-9, in the present non-limiting embodiment, the surrogate graphical user interface S.GUI displays (or in other words the processor module 104, by executing the instructions 106B, displays) the surrogate active areas S.A1, S.A2, . . . S.An on the display 102 one active area at a time. That is, as shown in FIG. 7, when surrogate active area S.A1 is displayed, all other active area(s) S.A2, . . . S.An are invisible on the display 102. In this embodiment, a user U of the device 100 may switch the display 102 between a displayed surrogate active area, e.g. S.A1, and another one of the surrogate active areas S.A1, S.A2, S.A3, e.g. S.A.2, via one or more user inputs. The one or more user inputs may be conventional, such as a swipe or other gesture over the display 102 in embodiments where the display 102 is a touchscreen, one or more actuations over one or more buttons of the device 100, etc. Stated more broadly, the processor module 104 may be configured (for example, via corresponding programming of the instructions 106B) to switch between displaying a given one of the surrogate active areas S.A1, S.A2, S.A3 and displaying another one of the surrogate active areas S.A1, S.A2, S.A3, . . . S.An in response to a pre-defined user input.

In other embodiments, the instructions 106B may be implemented to cause the processor module 104, when executed by the processor module 104, to display more than one of the surrogate active areas S.A1, S.A2, S.A3, . . . S.An at a time. As an example, referring to FIG. 7, in some embodiments, each contact in the contact list CL may be displayable in a surrogate active area, with two or more of the surrogate active areas being displayable on the display 102 simultaneously. In such embodiments, the processor module 104 may switch between displaying the given two or more of the surrogate active areas S.A1, S.A2, S.A3, . . . S.An and displaying one of the other surrogate active areas S.A1, S.A2, S.A3, . . . S.An in response to a user input, such as a swipe over the display 102 (where the display is a touchscreen). While the “one-at-a-time” surrogate active areas S.A1, S.A2, S.A3, . . . S.An provides one or more advantages in some applications of the device 100, it is contemplated that other combinations, such as the non-limiting example combinations above, may be used and may provide one or more advantages in some applications. Finally, it is contemplated that the surrogate graphical user interface S.GUI may have any suitable number of surrogate active areas S.A1, S.A2, . . . S.An, depending on each particular application thereof for example, including a single active area and three or more active areas.

According to the present technology, and as shown in FIG. 6, one or more of the surrogate active areas S.A1, S.A2, S.A3, . . . S.An may be mapped to one or more of the functions F1, F2, F3, . . . Fn of the application 106C. As an example, and as shown in FIG. 6, in the present non-limiting embodiment, the surrogate active area S.A1 is mapped to the contacts access function F1 and the call function F2 of the communications application 106C. For the present embodiment, this means that when the processor module 104 displays the surrogate graphical user interface S.GUI and the surrogate active area S.A1 on the display 102 instead of the GUI 110, the surrogate active area S.A1 is actuatable (for example by any suitable pre-determined one or more user inputs, such as touch input(s) in this embodiment) to cause the processor module 104 to execute the function F1 and/or the function F2, while maintaining both: a) the surrogate graphical user interface S.GUI/surrogate active area S.A1 on the display 102 instead of the GUI 110, and b) the application 106C active or at least executable in response to the one or more pre-determined user inputs, at least with respect to the function(s) F1 and/or F2.

More broadly, the processor module 104 may be said to be configured (by appropriate programming of the instructions 106B for example) to display the surrogate active area S.A1 on the display 102 while maintaining both the GUI 110 of the application 106C invisible on the display 102 and the application 106C executable at least with respect to the function(s) to which the surrogate active area S.A1 is mapped, such that the function(s) is/are executable via the surrogate active area S.A1 while the GUI 110 of the application 106C is invisible on the display 102. An embodiment of this configuration is described in more detail below.

Referring to FIG. 7, in this non-limiting embodiment, the surrogate active area S.A1, when displayed on the display 102 instead of the GUI 110, displays a scrollable sequence 700 of contacts in the contact list CL (i.e. contacts that are associated with the contacts access function F1 of the application 106C). Hence, with respect to the particular example of the application 106C of FIG. 3, the contact 702 may correspond to “John Doe”, the contact 704 may correspond to “Mary Smith”, and so on. The scrollable sequence 700 may display in the surrogate active area S.A1 at least one of the contacts of the contact list CL at a time, and in this embodiment displays multiple ones of the contacts at a time and is scrollable up and down in response to respective sliding touch inputs received by the processor module 104 via the touchscreen 102. Other scroll directions and contact display arrangements are likewise contemplated.

In this embodiment, and although this need not be the case in all embodiments, the scrollable sequence 700 is non-alphanumeric (i.e. excludes text), meaning that each of the contacts is displayed by a unique non-alphanumeric representation 706. As shown in FIG. 7, in this embodiment the unique non-alphanumeric representation 706 one or more of the contact(s) is a photograph of the user(s) associated with the one or more contact(s). I.e. for a given contact (e.g. a telephone number, and/or address and/or email, etc.), the unique non-alphanumeric representation 706 may be a photograph of a user associated with the given contact. In other embodiments, one or more of the unique non-alphanumeric representations 706 may be of a different type, such as one or more patterns, icons, avatars, etc., and may be sourced/accessible using any suitable method, with the latter thus not being described herein in detail. In an aspect, the non-alphanumeric scrollable sequence 700 may be easier to use for at least some users, such as at least some users with a particular cognitive challenge, such as dyslexia to give a non-limiting example.

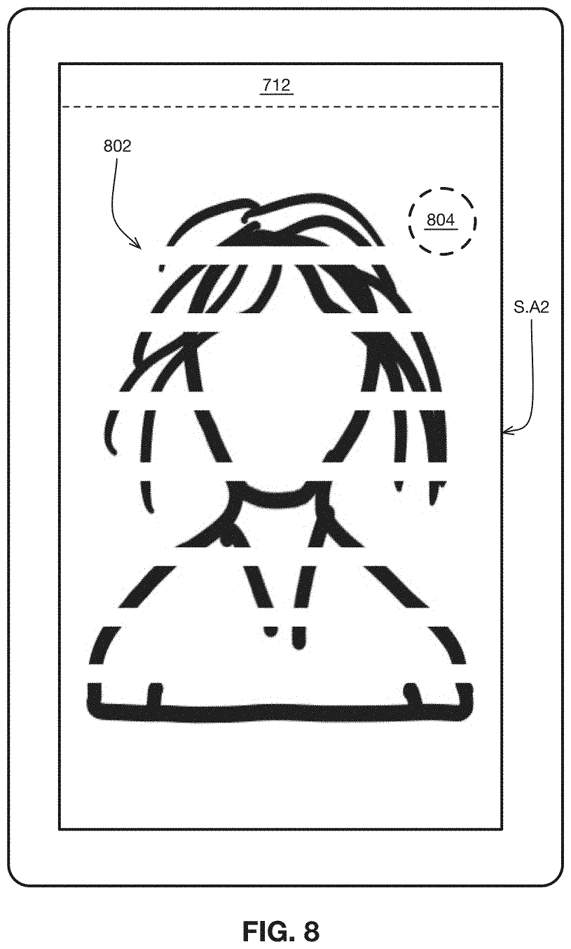

Still referring to FIG. 7, in this embodiment, the call function F2 (which is a non-limiting example of different possible connect functions) is executable by the processor module 104 with respect to a given one of the contacts, for example contact 702 (“John Doe”), in response to a user input (e.g. touch input) 708 received at a portion 710 of the surrogate active area S.A1/display 102 displaying the given contact 702 without the processor module 104 waiting to receive further user input after receiving the user input 708. In other words, in this embodiment, as soon as the user U, for example, taps the touchscreen 102 over a contact that the user U wishes to call, the processor module 104 executes the call function F2 by executing at least a corresponding part of the application 106C (i.e. with the GUI 110 thereof being invisible on the display 102) and without requiring the user to provide any further user input. Further in the present embodiment, and as shown in FIG. 8, additionally in response to receiving the user input 708 over the portion 710 and without requiring further user input, the processor module 104/surrogate graphical user interface S.GUI displays another surrogate active area S.A2 of the surrogate graphical user interface S.GUI on the touchscreen 102 instead of both the surrogate active area S.A1 and the GUI 110.

As shown in FIG. 8, in this embodiment the surrogate active area S.A2 displays a non-alphanumeric representation 802, in this example a partially transparent and/or lined rendering of the photograph associated with the contact with respect to which the call function F2 is being executed. This non-alphanumeric representation 802 may be displayed while the connection attempt stage of the call function F2 is being executed. As shown in FIG. 6, in this embodiment, the surrogate active area S.A2 is mapped to a call termination function F4 of the application 106C. Accordingly, referring back to FIG. 8, in response to receiving a user input 804 (in this embodiment, touch input 804, in other embodiments could be for example a mouse click) over the surrogate active area S.A2 while the surrogate active area S.A2 is displayed on the display 102 and without waiting for further user input, the processor module 104, by executing at least a corresponding part of the application 106C terminates the call function F2 and returns to displaying the surrogate active area S.A1. Also in this embodiment, if the connection attempt/call function F2 fails, the processor module 104 likewise returns to displaying the surrogate active area S.A1 without waiting for further user input.

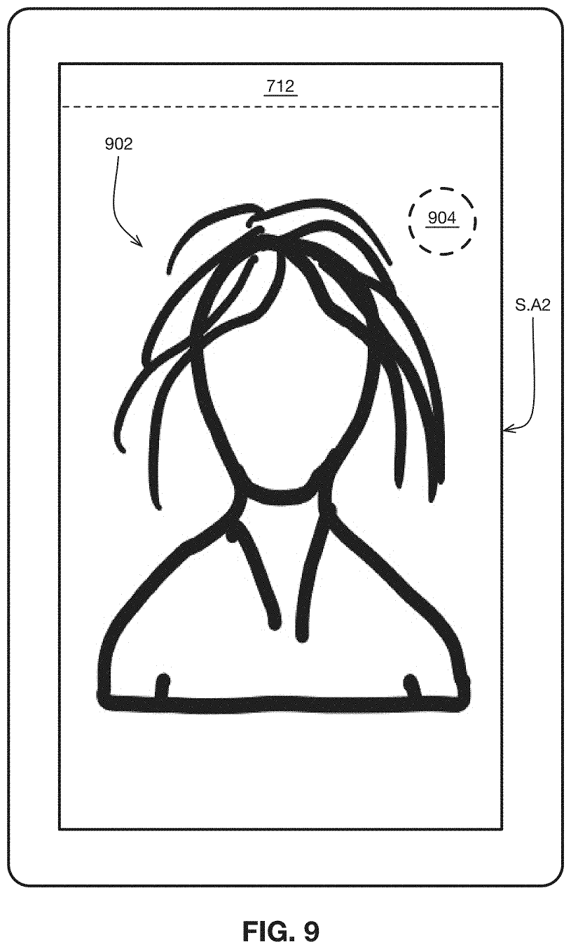

Further in this embodiment, and now referring to FIG. 9, if the connection attempt succeeds and a connection with a device associated with the given user is established (e.g. voice and/or video exchange connection 204 with device D2 associated with user U2, shown in FIG. 2 for example), the processor module 104 displays in the surrogate active area S.A2 a different non-alphanumeric representation 902 of the contact. In this example, the different non-alphanumeric representation 902 is a more prominent render (e.g. non-transparent render) of the photograph associated with the contact with respect to which the call function F2 is being executed. This non-alphanumeric representation 902 may be displayed while the connection (e.g. 204, FIG. 2) between the device 100 and the other device (e.g. D2, FIG. 2) is maintained. Since in this embodiment the surrogate active area S.A2 is mapped to the call termination function F4, in response to receiving a user input (e.g. touch input 904) over the surrogate active area S.A2 while the surrogate active area S.A2 is displayed on the display 102 and without waiting for further user input, the processor module 104, again by executing the corresponding functionality of the application 106C without displaying the GUI 110, terminates the connection 204/call function F2 and returns to displaying the surrogate active area S.A1 (FIG. 7).

Referring to FIGS. 8-9, the non-alphanumeric representations 802, 902, and the respective surrogate active area(s), when displayed, may occupy between 80% and 100% of the display 102. More broadly, in some embodiments, the size of one or more of the surrogate active areas S.A1, S.A2, . . . S.An of the S.GUI may be in a range of 80% and 100% of the size of the display 102. In an aspect, the 800, to 100% sizing may help improve accessibility of the S.GUI to a user U that has special motor function needs and/or special vision needs, to give non-limiting examples.

In an aspect, as seen from the above, the surrogate graphical interface S.GUI may be configured to provide to a user U with a different layout and/or a different representation of information and/or subset of the functions F1, F2, . . . Fn than that which is/are provided by the application 106C. For example, where the application 106C may have, say fifteen active areas A1, A2, . . . An and twenty functions F1, F2, . . . Fn, the surrogate graphical interface S.GUI may be configured to provide for example three of the functions F1, F2, . . . Fn (e.g. F1, F2, and F4, as described above), via a smaller number of surrogate active areas (e.g. S.A1, S.A2, as described above). Accordingly, in an aspect, the surrogate graphical interface S.GUI may allow to provide a relatively more accessible and/or intuitive way of executing one or more functions of the device 100, while using the existing functionality of the application 106C.

The present technology may thus reduce the extent of development efforts that may be required in order to provide each particular accessible/custom graphical user interface. As an example, a developer may avoid having to build up functions (such as functions F1, F2, F3 in the non-limiting example above) from scratch when developing an accessible graphical interface by instead mapping surrogate active area(s) to existing functions of an existing application (e.g. Skype™, Whatsapp™, etc.). The present technology may further help reduce software maintenance efforts. As an example, updates may be made to the application(s) 106C, 106C′ . . . 106Cⁿ by the developers/proprietors of the application(s) 106C, 106C′ . . . 106Cⁿ. In at least some embodiments and in at least some cases, it is contemplated that the mapping of the present technology may thus take advantage of the updates without necessarily requiring an update to the surrogate graphical interface S.GUI or the instructions 106B.

Additionally, in some embodiments, the surrogate graphical interface S.GUI may be configurable (e.g. via the device 100 or via a remote connection) to establish and/or change the mapping of the one or more of the surrogate active areas S.A1, S.A2 . . . S.An to the one or more functions F1, F2, . . . Fn and/or to which particular application(s) 106C, 106C′ . . . 106Cⁿ the surrogate active area(s) S.A1, S.A2 . . . S.An is/are mapped. This may allow a particular embodiment of the surrogate graphical interface S.GUI to be developed to accommodate for a particular subgroup of users for example while not being tied to any particular application. Accordingly, the present technology may be relatively more efficient and/or flexible than at least some prior art technologies.

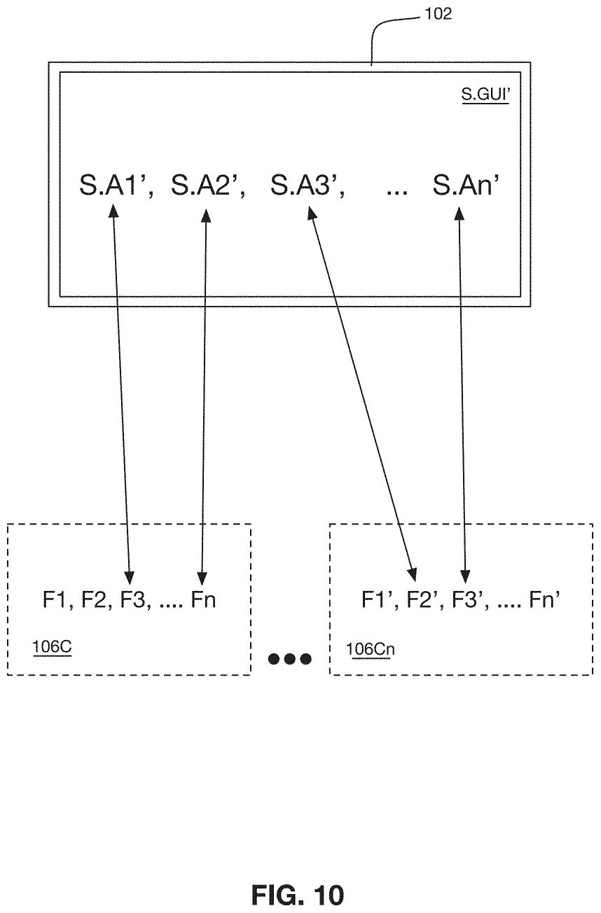

Now referring to FIG. 10, another non-limiting embodiment of the surrogate graphical interface S.GUI′, and hence another non-limiting embodiment of the instructions 106B in FIG. 1, are shown schematically. In this embodiment, the surrogate graphical interface S.GUI′ includes multiple surrogate active areas S.A1′, S.A2′, S.A3′, S.A4′, . . . S.An, some of which are mapped to function(s) F1, F2, etc., of one application 106C, and others of which are mapped to function(s) F4′, F5′, . . . Fn′ of other application(s) 106Cⁿ. Similar to the first embodiment described above, the surrogate graphical interface S.GUI′ may be configurable to establish a given set of the s.area(s)-to-function(s) mappings, and/or to change the s.area(s)-to-function(s) mappings, via any suitable way via the device 100 and/or via a remote connection, such as a remote connection 206 (FIG. 2) from a device Dn.

In another aspect, the present technology may thus be used to provide a user U of the device 100 with one or more functions of two or more different ones of the applications 106C, 106C′ . . . 106Cⁿ executable by the device 100, via a single surrogate graphical interface S.GUI′. In at least some embodiments and applications, this may allow to reduce development efforts required of the developer(s) of the instructions 106B/surrogate graphical interface S.GUI′, and/or may allow to construct a relatively more customized/accessible surrogate graphical interface S.GUI′ to better suit the needs of particular type(s) of user. In yet another aspect, in at least some embodiments the present technology may allow to reduce maintenance/updates that may be required with respect to the surrogate graphical interface S.GUI′, because maintenance/updates may be implemented by the developers of the application(s) 106C, 106C′ to which the surrogate graphical interface S.GUI′ may be mapped and may hence automatically become available via the surrogate graphical interface S.GUI′. More broadly, the present technology may provide relatively more flexible and/or efficient methods/GUIs.

In view of the foregoing, and as shown in the figures of the present application, various possible embodiments of the present technology may be described as the following clauses:

Clause 1. A device, comprising: a display, a processor module operatively connected with the display, and a memory module operatively connected with the processor module, the memory module storing: an application executable by the processor module to display a graphical user interface (GUI) on the display and to provide a plurality of functions executable via the GUI, and instructions executable by the processor module to display a surrogate active area on the display instead of the GUI, the surrogate active area mapped to a function of the plurality of functions.

Clause 2. The device of clause 1, wherein the processor module is configured to display the surrogate active area on the display while simultaneously maintaining both: a) the GUI of the application invisible on the display, and b) the application executable at least with respect to the function such that the function is executable via the surrogate active area while the GUI of the application is invisible on the display.

Clause 3. The device of clause 1 or 2, wherein: the surrogate active area is a plurality of surrogate active areas; the function is a plurality of functions; and each surrogate active area of the plurality of surrogate active areas is mapped to at least one function of the plurality of functions.

Clause 4. The device of clause 3, wherein: the application is a plurality of applications; a first surrogate active area of the plurality of surrogate active areas is mapped to at least one function of a first application of the plurality of applications; and a second surrogate active area of the plurality of surrogate active areas is mapped to at least one function of a second application of the plurality of applications.

Clause 5. The device of clause 3 or 4, wherein the instructions are executable by the processor module to cause the processor module to display a given surrogate active area of the plurality of surrogate active areas on the display while simultaneously maintaining both: a) a rest of the plurality of surrogate active areas and the GUI invisible on the display, and b) the application executable with respect to the at least one function to which the given active area is mapped.

Clause 6. The device of clause 3 or 4, wherein the processor module is configured to display a given surrogate active area of the plurality of surrogate active areas on the display while simultaneously maintaining both: a) a rest of the plurality of surrogate active areas and the GUI invisible on the display, and b) the application active with respect to the at least one function to which the given active area is mapped.

Clause 7. The device of clause 5 or 6, wherein the processor module is configured to switch between displaying on the display the given active area and another active area of the plurality of surrogate active areas in response to a user input received at the processor module.

Clause 8. The device of clause 1 or 2, wherein: the function is a plurality of functions that includes: a connect function executable via a first area of the GUI when the GUI is displayed on the display to connect the device with another device for exchanging with the other device one or both of speech and video, and a contacts access function executable via a second area of the GUI when the GUI is displayed on the display to display a plurality of contacts via the display; and the surrogate active area is mapped to both the connect function and the contacts access function.

Clause 9. The device of clause 8, wherein: the connect function is executable via at least a part of the surrogate active area; and the contacts access function is executable via at least the part of the surrogate active area.

Clause 10. The device of clause 9, wherein: the display is a touchscreen, the surrogate active area, when displayed on the touchscreen, displays in the surrogate active area a scrollable sequence of contacts that are associated with the contacts access function of the application, the scrollable sequence displaying in the surrogate active area at least one of the contacts at a time; and the connect function is executable by the processor module with respect to the at least one of the contacts in response to a touch input received at a portion of the touchscreen displaying the at least one of the contacts without the processor module waiting to receive further user input after receiving the touch input.

Clause 11. The device of clause 9 or 10, wherein the surrogate active area, when the surrogate active area is displayed on the touchscreen, occupies between 80% and 100% of the touchscreen.

Clause 12. The device of clause 11, wherein the portion of the touchscreen displaying the at least one of the contacts, when the surrogate active area is displayed on the touchscreen, occupies between 30% and 100% of the surrogate active area (e.g. as shown in FIG. 7).

Clause 13. The device of clause 12, wherein the portion of the touchscreen displaying the at least one of the contacts, when the surrogate active area is displayed on the touchscreen, occupies between 80% and 100% of the surrogate active area.

Clause 14. The device of any one of clauses 8 to 10, wherein the device includes a communications module operatively connected with the processor module, and the communications module is operable to execute a connection attempt with respect to a device associated with the at least one of the contacts in response to the connect function being executed by the processor module.

Clause 15. The device of clause 10, wherein the scrollable sequence is non-alphanumeric.

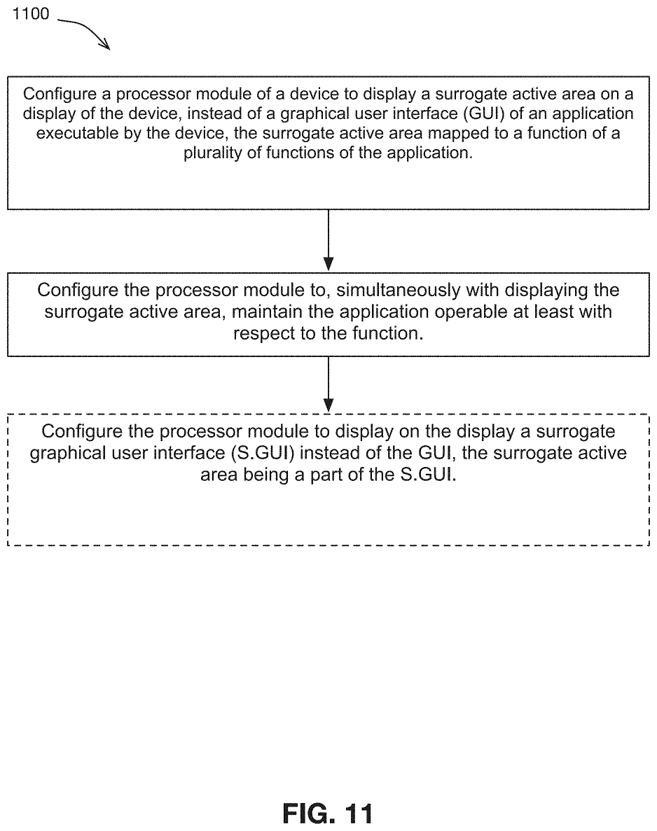

Clause 16. A method 1100 (FIG. 11) of configuring a device, such as the device, having a display and an application executable on the device to display a graphical user interface (GUI), the application having a plurality of functions executable by a user via the GUI, the method comprising: configuring a processor module of the device to simultaneously: display a surrogate active area on the display instead of the GUI, the surrogate active area mapped to a function of the plurality of functions, and maintain the application operable by the processor module at least with respect to the function such that the application is executable by the processor module in response to a user input received by the processor module with respect to the surrogate active area.

Clause 17. The method of clause 16, further comprising configuring the processor module to display a surrogate graphical user interface (S.GUI) on the display instead of the GUI while maintaining the application operable by the processor module at least with respect to the function, the surrogate active area being a part of the S.GUI.

Clause 18. The method of clause 16 or 17, wherein the user input is a second user input, and further comprising configuring the processor module to display the surrogate active area on the display instead of the GUI in response to a first user input.

Clause 19. The method of any one of clauses 16 to 18, wherein the configuring the processor module includes modifying an operating system of the device.

Clause 20. The method of any one of clauses 16 to 19, wherein the configuring the processor module includes storing instructions at least in part in a memory module of the device, the instructions being executable by the processor module to cause the processor module to simultaneously: display the surrogate active area on the display instead of the GUI, the surrogate active area mapped to the function of the plurality of functions, and maintain the application operable by the processor module at least with respect to the function such that the application is executable by the processor module in response to the user input received by the processor module with respect to the surrogate active area.

Clause 21. A mobile device, comprising: a touchscreen; a processor module operatively connected with the touchscreen; a communications module operatively connected with the processor module and operable to exchange at least voice data between a user of the device and a user of another voice-exchange-capable device; and a memory module operatively connected with the processor module and storing instructions executable by the processor module to display on the touchscreen a scrollable non-alphanumeric sequence of a plurality of contacts associated with the device, the scrollable non-alphanumeric sequence, when displayed on the touchscreen, displaying at least one of the contacts at a time and occupying between 80% and 100% of the touchscreen.

Clause 22. The device of clause 21, wherein the processor module is configured to execute a connection attempt via the communications module with respect to a device associated with the at least one of the contacts in response to a touch input received at a portion of the touchscreen displaying the at least one of the contacts without waiting to receive further user input after receiving the touch input.

Clause 23. The device of clause 21 or 22, wherein the processor module is configured to, in response to receiving the touch input and without waiting to receive further user input after receiving the touch input, display a non-alphanumeric representation of the at least one contact on the touchscreen while the connection attempt is being executed, the non-alphanumeric representation occupying between 80% and 100% of the touchscreen.

Clause 24. The device of clause 23, wherein the processor module is configured to, in response to the connection attempt establishing a connection with the device associated with the at least one of the contacts, display another non-alphanumeric representation of the at least one contact on the touchscreen, the other non-alphanumeric representation occupying between 800/% and 100% of the touchscreen.

Clause 25. The device of clause 24, wherein the processor module is configured to, in response to receiving a touch input at the touchscreen over the other non-alphanumeric representation, terminate the connection without waiting to receive further user input after receiving the touch input over the other non-alphanumeric representation.

A person of ordinary skill in the art reading the present document will in light of the teachings of the document realize that many modifications may be made to the present technology without departing from the scope of the present technology. As an example, in some embodiments, the S.GUI may be the sole GUI displayed on the display 102 when the instructions 106B are executed, while in other embodiments the S.GUI may be displayed on the display 102 along with other elements/information, such as for example a status bar/icon(s)/element(s) (712, FIGS. 7-9) displaying information about the device 100 and/or actuatable elements for executing certain functions on the device 100.

As another example, the instructions 106B have been shown schematically in FIG. 1 as a single module of instructions, such as for example an application which may be executable by the processor module 104 in response to a user input, such as for example a tap over a shortcut/icon displayable on the display 102 and associated with the application. However, a person skilled in the art would understand that this has been done merely to maintain clarity and simplicity of the description, and that the instructions 106B may be implemented in any suitable way, such as but not limited to two or more software and/or hardware modules, and/or in a distributed fashion (e.g. at least in part on the cloud), and/or may be stored in different physical and/or virtual parts of the memory module 106 and/or at least in part on the cloud, so long as the functionality described herein is provided. As a particular non-limiting example, in some embodiments, the instructions 106B may be part of an operating system of the device 100.

Further, the skilled person will understand that the device 100 as configured and described herein, and the methods as described herein, may be implemented using conventional one or more programming languages and/or hardware selected to suit each particular embodiment of each particular device, S.GUI(s), application(s), and/or intended uses of each of these elements.

1. A device, comprising:
a display,
a processor module operatively connected with the display, and
a memory module operatively connected with the processor module, the memory module storing:
an application executable by the processor module to display a graphical user interface (GUI) on the display and to provide a plurality of functions executable via the GUI, and
instructions executable by the processor module to display a surrogate active area on the display instead of the GUI, the surrogate active area mapped to a function of the plurality of functions.

2. The device of claim 1, wherein the processor module is configured to display the surrogate active area on the display while simultaneously maintaining both: a) the GUI of the application invisible on the display, and b) the application executable at least with respect to the function such that the function is executable via the surrogate active area while the GUI of the application is invisible on the display.

3. The device of claim 2, wherein:
the surrogate active area is a plurality of surrogate active areas;
the function is a plurality of functions; and
each surrogate active area of the plurality of surrogate active areas is mapped to at least one function of the plurality of functions.

4. The device of claim 3, wherein:
the application is a plurality of applications;
a first surrogate active area of the plurality of surrogate active areas is mapped to at least one function of a first application of the plurality of applications; and
a second surrogate active area of the plurality of surrogate active areas is mapped to at least one function of a second application of the plurality of applications.

5. The device of claim 3, wherein the instructions are executable by the processor module to cause the processor module to display a given surrogate active area of the plurality of surrogate active areas on the display while simultaneously maintaining both: a) a rest of the plurality of surrogate active areas and the GUI invisible on the display, and b) the application executable with respect to the at least one function to which the given active area is mapped.

6. The device of claim 3, wherein the processor module is configured to display a given surrogate active area of the plurality of surrogate active areas on the display while simultaneously maintaining both: a) a rest of the plurality of surrogate active areas and the GUI invisible on the display, and b) the application active with respect to the at least one function to which the given active area is mapped.

7. The device of claim 6, wherein the processor module is configured to switch between displaying on the display the given active area and another active area of the plurality of surrogate active areas in response to a user input received at the processor module.

8. The device of claim 2, wherein:
the function is a plurality of functions that includes:
a connect function executable via a first area of the GUI when the GUI is displayed on the display to connect the device with another device for exchanging with the other device one or both of speech and video, and
a contacts access function executable via a second area of the GUI when the GUI is displayed on the display to display a plurality of contacts via the display; and
the surrogate active area is mapped to both the connect function and the contacts access function.

9. The device of claim 8, wherein:
the connect function is executable via at least a part of the surrogate active area; and
the contacts access function is executable via at least the part of the surrogate active area.

10. The device of claim 9, wherein:
the display is a touchscreen,
the surrogate active area, when displayed on the touchscreen, displays in the surrogate active area a scrollable sequence of contacts that are associated with the contacts access function of the application, the scrollable sequence displaying in the surrogate active area at least one of the contacts at a time; and
the connect function is executable by the processor module with respect to the at least one of the contacts in response to a touch input received at a portion of the touchscreen displaying the at least one of the contacts without the processor module waiting to receive further user input after receiving the touch input.

11. The device of claim 9, wherein the surrogate active area, when the surrogate active area is displayed on the touchscreen, occupies between 80% and 100% of the touchscreen.

12. The device of claim 11, wherein the portion of the touchscreen displaying the at least one of the contacts, when the surrogate active area is displayed on the touchscreen, occupies between 30% and 100% of the surrogate active area.

13. The device of claim 12, wherein the portion of the touchscreen displaying the at least one of the contacts, when the surrogate active area is displayed on the touchscreen, occupies between 80% and 100% of the surrogate active area.

14. The device of claim 10, wherein the device includes a communications module operatively connected with the processor module, and the communications module is operable to execute a connection attempt with respect to a device associated with the at least one of the contacts in response to the connect function being executed by the processor module.

15. The device of claim 10, wherein the scrollable sequence is non-alphanumeric.

16. A method of configuring a device having a display and an application executable on the device to display a graphical user interface (GUI), the application having a plurality of functions executable by a user via the GUI, the method comprising:
configuring a processor module of the device to simultaneously:
display a surrogate active area on the display instead of the GUI, the surrogate active area mapped to a function of the plurality of functions, and
maintain the application operable by the processor module at least with respect to the function such that the application is executable by the processor module in response to a user input received by the processor module with respect to the surrogate active area.

17. The method of claim 16, further comprising configuring the processor module to display a surrogate graphical user interface (S.GUI) on the display instead of the GUI while maintaining the application operable by the processor module at least with respect to the function, the surrogate active area being a part of the S.GUI.

18. The method of claim 16, wherein the user input is a second user input, and further comprising configuring the processor module to display the surrogate active area on the display instead of the GUI in response to a first user input.

19. The method of claim 16, wherein the configuring the processor module includes modifying an operating system of the device.

20. The method of claim 16, wherein the configuring the processor module includes storing instructions at least in part in a memory module of the device, the instructions being executable by the processor module to cause the processor module to simultaneously:
display the surrogate active area on the display instead of the GUI, the surrogate active area mapped to the function of the plurality of functions, and
maintain the application operable by the processor module at least with respect to the function such that the application is executable by the processor module in response to the user input received by the processor module with respect to the surrogate active area.
